(19) United States
(12) Patent Application Publication
(10) Pub. No.: US 2010/0201082 A1
(43) Pub. Date: Aug. 12, 2010

(54) Multilayer Seal for a Container

(76) Inventor: Jamie R. Hart, Byron Center, MI (US)

Correspondence Address: MILLER, CANFIELD, PADDOCK AND STONE, 277 SOUTH ROSE STREET, SUITE 5000, KALAMAZOO, MI, 49007, US

(21) Appl. No.: 12/429,649

(22) Filed: Apr. 24, 2009

Related U.S. Application Data
(60) Provisional application No. 61/047,658, filed on Apr. 24, 2008.
(60) Provisional application No. 61/047,666, filed on Apr. 24, 2008.

(51) Int. Cl. F16J 15/02

(52) U.S. Cl. 277/654

(57) ABSTRACT

A facilitated rupturable multilayer seal comprising a deformation layer and a layer free of deformation, or an upper portion and a lower portion, where the upper portion comprises a deformation layer and the lower portion comprises a layer free of deformation, where the deformation layer may be comprised of multiple layers; where the layer free of deformation may be comprised of multiple layers. The deformation layer and the layer free of deformation are combined and fixed to each other, and form a moisture and vapor resistant barrier. The multilayer seal allows for both containment of liquids, as well as separation of solids and liquids, with a solid impervious barrier and yet it is easily broken, allowing either access to, or transfer of, a solid or liquid out of or into a container, including the mixing of a solid with a liquid or a liquid with a liquid.

### CROSS-REFERENCE TO RELATED APPLICATIONS

This application asserts priority from U.S. application 61/047,658 and U.S. application 61/047,666, both filed Apr. 24, 2008, which are incorporated herein by reference.

### FIELD OF THE INVENTION

This invention is related to the field of seals and barriers; containers and closures; and blister packs for dispensing solids and liquids.

### BACKGROUND OF THE DISCLOSURE

Blister packs and disposable juice containers are intended to provide easy access to contained solid pills or liquids. Frequently, the access is anything but easy. Better seals allowing for the enclosure and release of solids or access to liquids are needed. Before this, removing a pill from a typical blister pack was often difficult. Pills are not always easily removed from a blister pack. Often, the user ends up clawing, tearing, biting or using a scissors or knife to release the pill. Typical blister packs can be especially difficult to open for the young and the elderly. The problem is so vexing that numerous patents and applications are devoted to devices that break a blister pack and allow the pill to escape the blister. See for example, U.S. Pat. No. 7,249,690 B2, Smith, issued 31 Jul. 2007 describing a complex mechanical bottle cap for containing and dispensing single unit dosages. U.S. Pat. No. 6,609,612 B 2, Vlodek, issued 26 Aug. 2003 describing rings, valves and plungers for dispensing materials into bottles. Other devices are known.

Multilayer seals for containing liquids are also known. Seals that are designed to seal liquids or flowable materials in bottles and then burst open upon being squeezed or pressurized are also known. See for example, U.S. Pat. No. 7,237,698 B2, Jackman, issued 3 Jul. 2007, U.S. Pat. No. 7,337,928 B2, Jackman, issued 4 Mar. 2008 and related publications. While these seals may be effective when used with oils and materials with little or no water vapor pressure, they are not designed to provide a long shelf life for a solid that is sensitive to oxygen and water vapor. A seal designed to burst easily under fluid pressure will not have the proper characteristics required by a seal designed to prevent water liquids and gas vapors from permeating a barrier.

There is a need for better seals and systems that can be made quickly and at low cost that allows solids, including pills, stored adjacent to a container of aqueous liquid that are then easily transferred into the liquid container, with good shelf lives and without the need for mechanical pushers or seal cutters. The disclosure provides for a unique seal that allows both containment and separation of solids and liquids with a solid impervious barrier. The seal described herein can be easily manufactured, has a good shelf life and yet is also easily broken, allowing either access to, or transfer of, a solid or liquid out of or into a container, thus allowing for mixing of a solid with a liquid or a liquid with a liquid. The multilayer seal described herein allows a blister pack to be made that is easy and convenient to use, while still keeping the enclosed liquids, solids, or pills safe, secure and protected from exposure to vapors, moisture, humidity, liquids, contamination and the like for long periods of time.

### SUMMARY OF THE DISCLOSURE

A facilitated rupturable seal comprising a deformation layer and a layer free of deformation, where the deformation layer and the layer free of deformation are comprised of one or a multiplicity of layers; wherein, the deformation layer and the layer free of deformation are combined and fixed to each other to form a moisture and vapor resistant barrier. A facilitated rupturable seal comprising an upper portion and a lower portion, wherein the upper portion comprises a deformation layer and the lower portion comprises a layer free of deformation, where both the deformation portion and the portion free of deformation may be comprised of a multiplicity of layers or portions; or the two portions may be comprised of the same or substantially similar materials. The deformation portion and portion free of deformation form a whole comprising a moisture and vapor resistant barrier with both a deformation zone and a zone free of deformation.

The seal is comprised of multilayers or multizones of a single layer, and there can be a multiplicity of individual layers or zones, including from 2 to 40 layers of the same or different materials in either the layers of deformation or the layers free of deformation. Seals with 3, at least 4, at least 5, at least 6, at least 7, at least 8, at least 9 and at least 10 layers of materials are specifically described. The layers of the seal can be plastic or foil or a combination thereof.

The facilitated rupturable seal will have an overall seal thickness that gives it the following suitable ranges for a Water Entry Pressure WEP and Burst strength. When a pill dispensing application is desired a facilitated rupturable seal having a thickness that gives: 1) an Average Water Entry Pressure (WEP) of about 3.0 to 20.0 PSI and a burst strength of about 4.0-25.0 PSI, 2) an Average Water Entry Pressure (WEP) of about 7.0 to 12.0 PSI and a burst strength of about 7.0-10.0 PSI is disclosed, and 3) an Average Water Entry Pressure (WEP) of about 9.0 to 10.0 PSI and a burst strength of about 8.0-9.0 PSI is disclosed.

The facilitated rupturable seal may comprise a melt layer, or a melt layer and a backing layer; or a melt layer, a backing layer, and a foil layer, and/or, a melt layer, a backing layer, a foil layer, and a barrier layer. The layers of the seal can be made of polyolefin, and optionally PVdC and optionally foil. The layers of the seal can be made of polyolefin comprised of PE or PP or a combination of both; or PE and PVdC or a combination of both; or any combination of one or more PE, PVdC, and foil or any combination of all three materials; or PE, PVdC, PET, and foil or a combination of all four materials. The seal can be made of 2, 3, 4, 5, 6, 7, 8, 9 or 10 layers, and all the layers can be made of PE or any combination of the materials described herein.

A facilitated rupturable seal comprising a deformation layer and a layer free of deformation, wherein the deformation layer may be comprised of a multiplicity of layers and is comprised of a complete cut line through the layer; wherein the cut line has a thickness of about 0.002 to 0.510 mm in width; of about 0.012 mm to about 0.254 mm; or of about 0.025 to about 0.127 mm, wherein the layer free of deformation may be comprised of a multiplicity of layers; wherein the deformation layer and the layer free of deformation are combined and fixed to each other, wherein the combined deformation layer and a layer free of deformation form a moisture and vapor resistant barrier; wherein the deformation layer is comprised of either PE or PET and comprises one or a multiplicity of layers; wherein the layers free of deformation are comprised of PE, PET, PCTFE, Saran, FIFE, PVC, PS, Nylon, PVdC or foil and combinations thereof.

Some of the embodiments of the seal and the number of layers are: five layers comprising: a solid layer of PE; and deformable layers of PE or PET, foil and PVdC; five layers comprising: a solid layer of PE; and deformable layers of PE comprising low density PE, PET; medium density PE, foil, and PVdC; five layers comprising: a solid layer of PE, and four deformable layers comprising PE, PET, foil; and one deformation layers is made of PVdC; five layers comprising: a solid layer made of PE; the other four layers are deformation layers made of PE, PET, foil; and one deformable layers of PVdC, the deformation layer of PE is next to the solid layer of PE.

Some of the embodiments of the seal and the number of layers are: six layers comprising six layers made of compounds selected from PE, PET, foil, PVdC and polyolefin; six layers comprising two of the six layers made of PE, and the other four layers are made of materials selected from; PET, foil, PVdC and polyolefin; six layers comprising two layers of PE, and four layers are made of materials selected from PET, foil, PVdC and polyolefin; six layers comprising one PE layers as the layer free of deformable layer; six layers comprising two layers are made of PE, and four layers made of materials selected from PET, foil, PVdC and polyolefin where one of the PE layers is free of deformities and the other PE layer is a deformable layer adjacent to deformable free PE layer.

The multilayer seal may have a pattern to the deformable layer; the pattern of the deformation can be an open pattern, any of the shapes in FIG. 8, or in the shape of a spoon, the letter X, a spade, the letter “C” or a hinged “C” shape, or where the pattern is a “U” or a double triangle shape.

The multilayer seal is a facilitated rupturable seal that may be incorporated into a juice box and intended for rupture with a straw; or incorporated into a pill dispensing device that allows for rupture with hands or fingers to release the pill; or incorporated into a combination solid and liquid container that allows for rupture by pressing the pill through the seal into a liquid.

A facilitated rupturable seal made of six layers, comprising a deformation layer and a layer free of deformation, where the deformation layer is comprised of one layer; wherein, the layer free of deformation is comprised of five layers; wherein, the deformation layers and the layer free of deformation are combined and fixed to each other, wherein, the combined deformation layers and layer free of deformation form a moisture and vapor resistant barrier.

In one aspect of the disclosure, the facilitated rupturable multilayer seal is made of six layers of materials, reference is made to FIG. 5 where is seal is shown that comprises at least one layer free of deformation, at least one deformation layer with a deformation in the shape of a pattern, which, when combined, creates a seal with a patterned fault, the seal is moisture and vapor resistant barrier where two of the six layers are made of PE, one of the PE layers is a layer free of deformation (21) where this layer free of deformation (21) is comprised of PE of low density PE (LDPE) and the other layer of PE is a deformation layer of PE (1); where the deformation PE layer (1) is comprised of medium density PE (MDPE) and where this MDPE layer is adjacent to and bonded to the deformation free layer of low density PE (LDPE)(2); where the other four deformation layers are all adjacent to each other and the first deformation layer is comprised of medium density PE (1) placed adjacent to the other layers in the following order: second deformation layer (2) is PVdC or PET; third deformation layer (3) is foil; fourth deformation layer (4) is polyolefin; fifth deformation layer (5) PET; where the solid layer of PE (21) has a thickness of about 0.05 mm and the combined thickness of the deformation layers is about 0.25 to 0.30 mm thick.

### BRIEF DESCRIPTION OF THE DRAWINGS

FIG. 1 shows a perspective view of a facilitated rupturable seal comprised of two layers, one deformation layer and one solid layer. FIG. 1A shows a cross sectional view of the same image as FIG. 1.

FIG. 2 shows a perspective view of a facilitated rupturable seal comprised of three layers, two deformation layers and one solid layer. FIG. 2A shows a cross sectional view of the same image as FIG. 2.

FIG. 3 shows a perspective view of a facilitated rupturable seal comprised of four layers, three deformation layers and one solid layer. FIG. 3A shows a cross sectional view of the same image as FIG. 3.

FIG. 4 shows a perspective view of a facilitated rupturable seal comprised of five layers, four deformation layers and one solid layer. FIG. 4A shows a cross sectional view of the same image as FIG. 4.

FIG. 5 shows a perspective view of a facilitated rupturable seal comprised of six layers, five deformation layers and one solid layer. FIG. 5A shows a cross sectional view of the six layers.

FIGS. 6 and 6A show a facilitated rupturable seal comprised of five layers, three deformation layers and two solid layers. FIG. 6A shows a cross sectional view of the five layers.

FIGS. 7 and 7A show a facilitated rupturable seal comprised of eight layers, five deformation layers and three solid layers. FIG. 7A shows a cross sectional view of the eight layers.

FIG. 8 shows a sample of the various patterns of deformation that can be used with the facilitated rupturable seal. The cut or deformation line is shown.

FIG. 9 shows the facilitated rupturable seal placed on a liquid container, with the seal on top of the container.

FIG. 10 shows the facilitated rupturable seal placed on a liquid container, with the seal on the side of the container.

FIG. 11 shows a perspective view of the facilitated rupturable seal placed on top of a bottle container adapted for a straw use and showing ridges for a cap that could be screwed over the top of the seal.

FIG. 12 shows a perspective view of the facilitated rupturable seal on a bottle as shown in FIG. 11, only in FIG. 12 the seal is used with a pill and a cap is placed on top of the bottle. FIG. 12A shows a cross sectional view of the same image as FIG. 12.

FIG. 13 shows the seal in perspective, as used with pill under a layer of plastic placed over the pill. FIG. 13 A shows a cross sectional view of the image in FIG. 13.

FIG. 14 shows a perspective view of multiple pills resting on a sheet of facilitated rupturable seals having multiple rupturable patterns as in a typical blister pack used for pharmaceuticals. FIG. 14 A shows a cross sectional view of the image in FIG. 14.

### DETAILED DESCRIPTION OF THE DISCLOSURE

### Definitions

Unless noted otherwise, the words in “quotes” should be given the definitions provided below.

The term “backing layer” means the layer(s) of the seal that are on the outside of the seal. Backing layer(s) add support and integrity to the seal. They are stacked next to each other. In one embodiment, a backing layer faces the liquid in a container. There can be multiplicity of backing layers. Alternately, a backing layer can also be a melt layer, and or an internal barrier layer and or a foil layer depending on its position and the function it serves.

The term “break” means a rupture, or split or opening allowing passage of a solid or liquid, gas or vapor from one side of the break to the other. Here the term is usually used in association with the term seal which forms the barrier that is broken.

The term “burstability” refers to the ease with which a seal can be broken. Methods to measure burstability are provided.

The term “cut” means to pierce and divide or insert a separation in a material. Here one or multiple of layers of materials are bonded together and then a cut or scratch is made into or across the layers, usually by a fine line or small separation. The cut or scratch can be made by any type of cutter such as a; knife, blade, rotary cutter, rotary blade, laser, water cutter, sonic cutter, etc. Since this disclosure typically deals with small materials of less than 2 inches, the cuts are often fairly fine, but not always, leaving a cut out width of often less than two mm.

The term “cut layer” or “cut base layer” refers to the layer or layers of the seal that are cut, perforated or deformed in some manner. The cut is often made completely through the layer or layers from one side to the other. Depending on the materials used, the depth of the cut can be partial and not entirely through the layers. Where the cut layer is cut entirely from one side to the other, the term “completely cut” layer is used.

The term “deformation” means any of the following; a cut, gash, perforation, hole, fracture, deep indentation, mutilation, scar, or scratch that penetrates into or through the deformation layer.

The term “facilitated rupture” refers to a break made as a result of using the seal as described herein using a combination of deformation layers or zones and layers free of deformation or solid layers or zones free of deformation. The facilitated rupture break starts at the deformation.

The term “fault” is a break in the continuity of a layer or layers of the seal; a dislocation or separation in the plane of any layer of the seal. If the cutting device had gaps in the cutting blade, the gaps would leave faults in the line cut by the blade.

The term “foil layer” means any foil of any suitable thickness. Foil layers of thickness from 0.006 to 0.5 mm, 0.010 to 0.130 mm or 0.012 to 0.026 mm, will all work with the multilayer seal, the thickness used depending on the application needed and the other materials used.

The term “FS1-19” is the brand name of the five layer induction foil material available from Selig Sealing Products Inc. (Forrest, Ill. and Naperville, Ill.) Other manufacturers supply similar materials.

The term “internal barrier” means a layer that is sandwiched between other layers within either the deformation layer or the layer free of deformation. There may be one or a multiplicity of internal barrier layers.

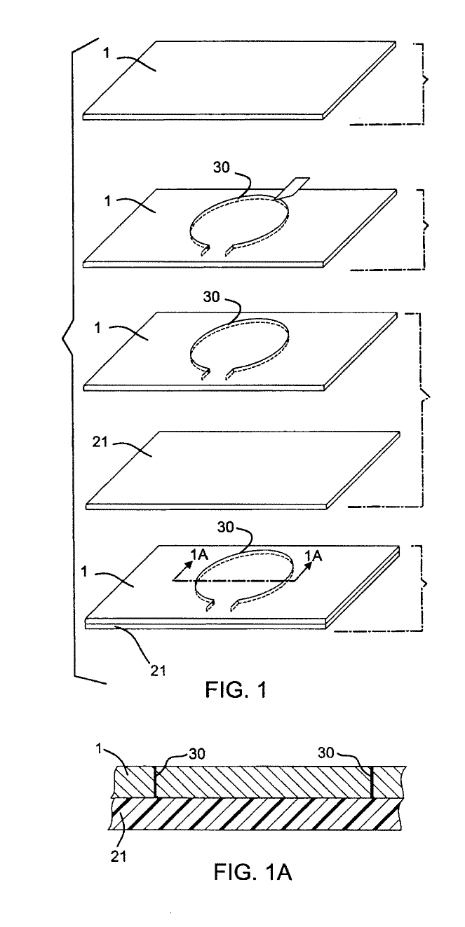

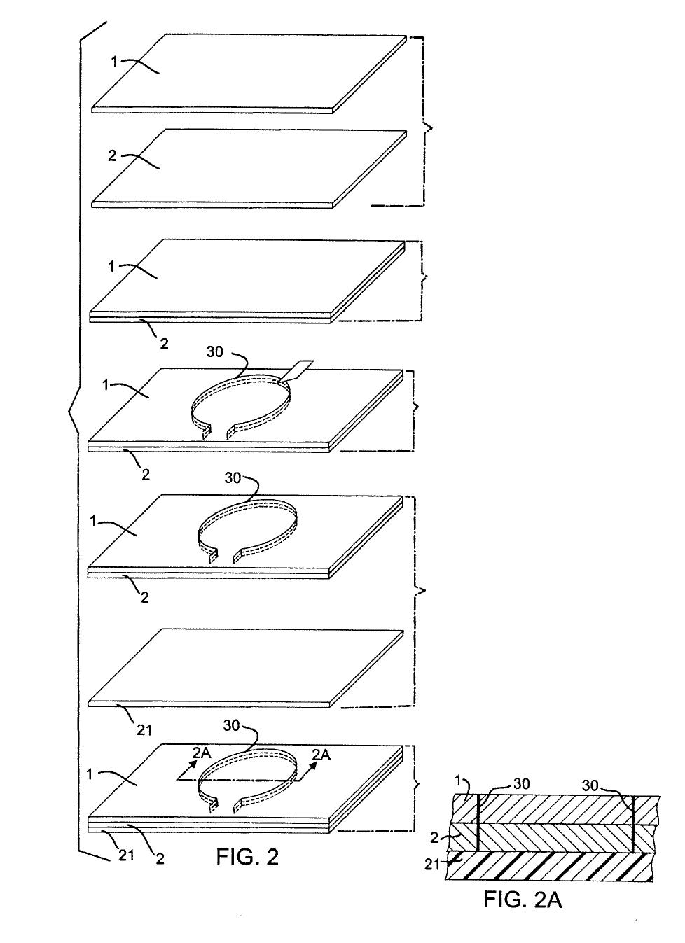

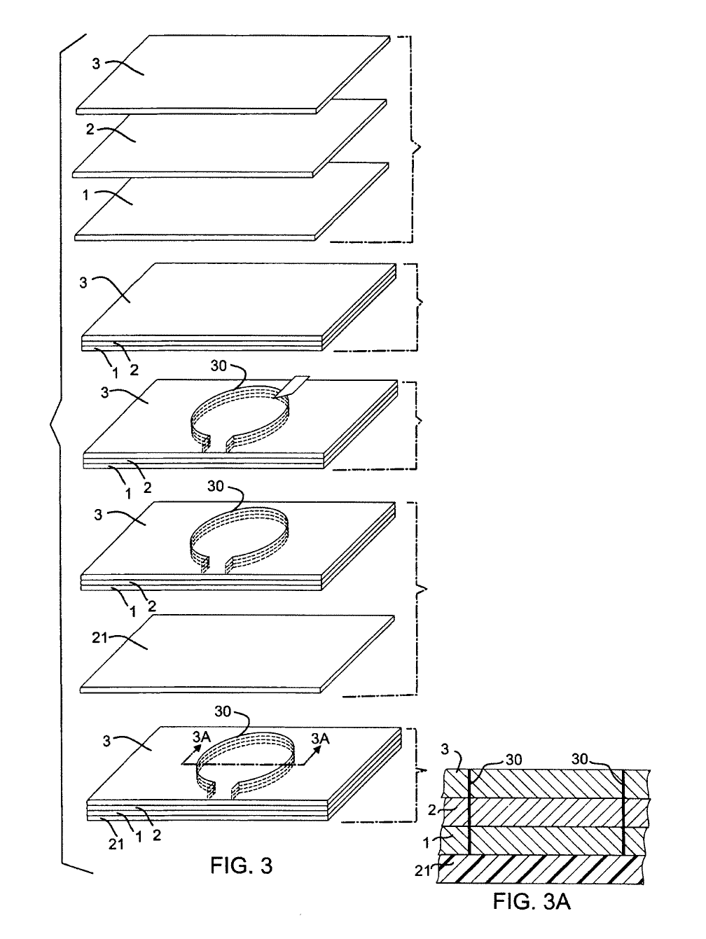

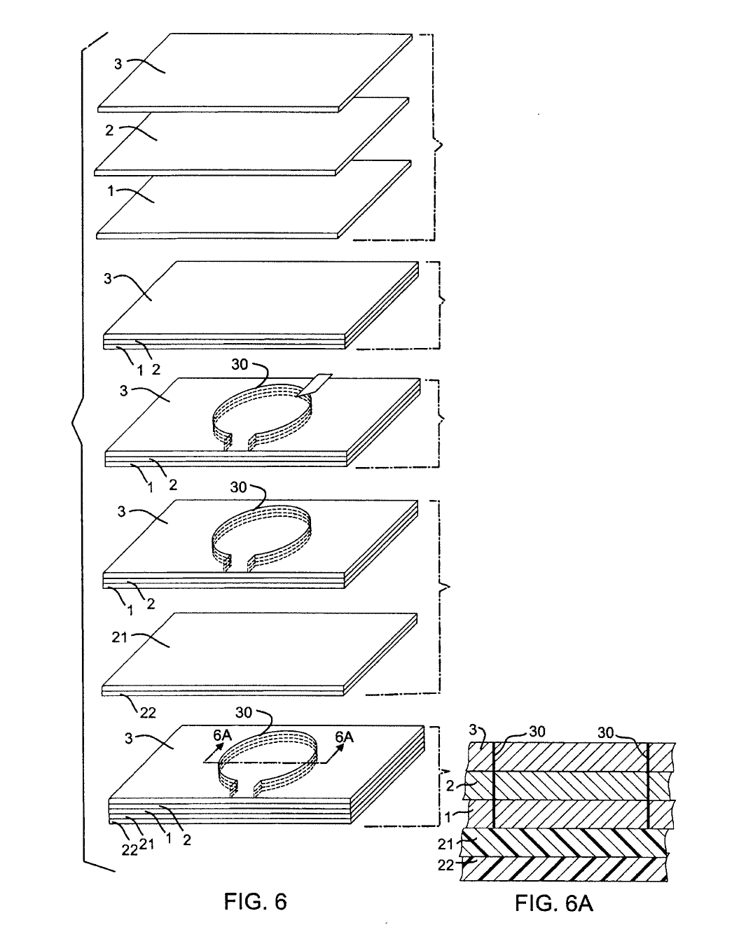

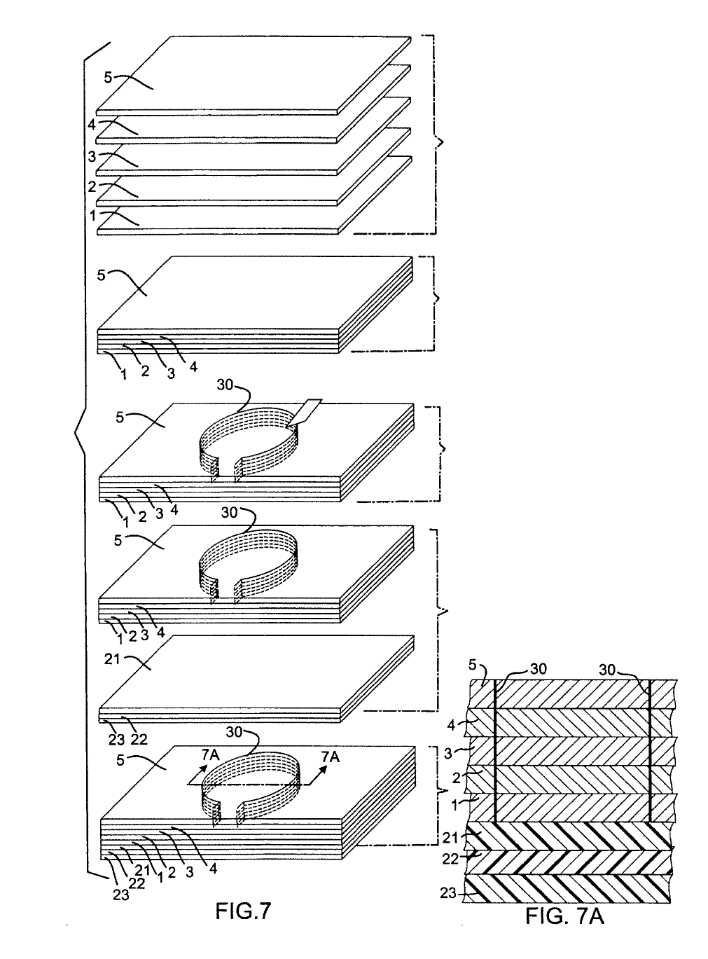

The term “melt layer” means a layer that permanently adheres to one of the layers combined with it. Typically, a melt layer will be one of the first deformation layers see item number (1) in FIGS. 1-7, 12A, 13 and 14. The melt layer is melted or made to bond in some fashion to the layer free of deformation.

The abbreviation “mm” means millimeter.

The term “pattern,” “pattern cut,” “patterned cut” “pattern of the cut,” “cut line,” “deformation line” “deformation pattern” or “pattern of the deformation” refers to the shape of the cut made in a layer, as viewed from above or below. The pattern can be any, point, line or shape, including a line with faults, perforations or gaps in the cut or pattern. The cut line, or deformation line, is formed by the cutting or deformation device and can be seen because of the small amount of material removed from one or more layers when the cut is made.

The term “PE” means polyethylene. PE can refer to any form, type, thickness or weight of polyethylene. Polyethylene is a thermoplastic commodity comprised of long chains of the monomer ethylene. It is sometimes called poly(methylene).

The term “PET” means polyethylene terephthalate. PET can refer to any form, type, thickness or weight of polyethylene terephthalate. PET is a thermoplastic polymer resin of the polyester family. It is manufactured under brand names Amite, Impet, Rynite and Ertalyte injection molding, Hostaphan, Melinex and Mylar films, and Dacron, Diolen, Terylene & Trevira fibers.

The term “pill” as used herein can be any solid, including: powders, granules, compressed or formed solid dry matter, capsule, tablet, coated or not, and the like. A pill is typically a solid form of a pharmaceutical, nutrient or food additive, nutritional supplement, sugar, candy, flavoring and the like. Pill can also include non food items for use with industrial applications.

The term “plastic” means any natural or synthetic material made into any type of line layer or thin foam layer. It includes, but is not limited to: Polyolefin's, including polyethylene (PE), in any form, including foam PE, low density polyethylene (LDPE), high density polyethylene (HDPE), linear low density polyethylene (LLDPE) polypropylene (PP), polyethylene terephthalate (PET, PETE, PETP or PET-P) see description under PET, above; Vinyl Alcohol (EVOH); polystyrene (PS); Polychlorotrifluoroethylene (PCTFE), which is sold under the brand name Aclar® by Honeywell®) or any other suitable flexible material including: foil, Kevlar®, nylon, polyester, PVdC, or other synthetic material and any of these materials with any known plastic additives.

The term “PVdC” is polyvinylidine chloride and has been called “plastic wrap.” It was at one time marketed and sold as Saran Wrap®. It is considered a PVC or Poly Vinyl Chloride derived material. It may contain a plasticizer such as bis(2-ethylhexyl) adipate (DEHA) or dibutyl phthalate (DBP) or bis(2-ethylhexyl) phthalate (DEHP).

The term “PE Foam” is Polyethylene that has a typical foam appearance which commonly has small pockets of air and tends to be thicker than thin layers and more compressible than a standard layer of PE.

The term “polyolefin” is a term that can be interchanged with “polyalkene” and is a general term that refers to any polymer produced from a monomer that is composed of a simple olefin. The term olefin used here can be interchanged with the term alkene. An example would be polypropylene, a common polyolefin made from the olefin propylene.

The term “rupture” means a break in the continuity of a material.

The term “rupturable” means the material can be broken open upon application of sufficient force or pressure to one side of the material, thus allowing movement of something across the rupture.

The term “multilayer seal” describes the multi layer device disclosed that has the rupturable fault and forms a liquid vapor barrier. It is a device with at least two layers, or zones; at least one layer or zone having a deformation to facilitate rupture, thus allowing movement of a solid or liquid from one side of the seal to the other, and another layer or zone that is free of deformation and substantially solid without a deformation.

The term “solid” means anything with less than 50% water, including: powders, granules, compressed or formed solid dry matter, capsule, tablet, coated or not, and the like. See Pill.

### General Description of the Disclosure

This disclosure comprises a seal that can be used in any application where at least one component is isolated, whether in a container, bubble or blister, and then later the isolated component is either released or accessed by rupturing the seal, whether by finger, straw, or implement, thus allowing the isolated component to escape or be accessed. The seal is also useful when keeping two or more components isolated and contained within a defined environment, or container, like a bottle or jar and later the two components are mixed together. In one aspect, the seal is used to contain a solid, or a liquid, and later the seal is ruptured allowing access to the solid or liquid. If a liquid is contained, it may be accessed with a drinking straw. Liquid into liquid uses are also possible and contemplated here. Typically, one volume of liquid is large, the other small, the seal allows the small volume to mix with the large. If the seal is used with a solid, the solid can be ejected into in a container, the hand or any place desired. In one aspect, the multilayer seal separates solids and liquids, and later, upon rupture of the seal, the solid and liquid are combined. This would be a solid liquid application for the seal.

The seal may be used with one or more solids or liquids or any combination thereof. It allows for movement of one or more components, flowing or mixing if desired, after rupture of the seal. The seal can easily be used in at least the three typical modes mentioned above, 1) solid, 2) liquid or 3) combination of solid and liquid.

The seal allows for a defined break or rupture along a well defined fault line. This type of a break or rupture is called a facilitated rupture. The facilitated rupture happens at a precise location on the seal, and it may be performed with a minimum of force. Broken pieces of the seal that could contaminate the liquid are not generated and are thus not a problem. The seal is easily ruptured or broken, even by a child, using only the pressure of a finger on a pill or by using a paper or plastic straw and without the need to resort to knives, scissors or other sharp, pointed, hard and sometimes dangerous implements that are often not clean and rarely sanitary.

Typically, the several layers of the deformation layer and layer free of deformation are purchased commercially either individually, stacked together or laminated. Alternately, the materials described herein can be made from their components which are described herein.

Solid only applications. The seal may be used with any type of solid having any form. Formed solids may be pills, tablets, capsules or the solid may not have a defined shape, it may simply be a formless powder, granulate, crumb, dust, seeds, coated powders and the like. One example of the seal used in a solid application would be a tablet or pill container often described as a “blister pack” and commonly used to contain drugs or nutrients for single pill dispensing where pills or solids are contained under a plastic bump, bubble or blister. Usually, a single dose is contained within each bubble. In the typical blister packs currently on the market, the pill is under a plastic bubble of some sort, and it sits on top and rests against a single or combination of a liner made of laminated layers of foil, plastic, paper. The laminated liner is broken or opened when the user wants access to the pills, tablets or powders. Often paper or cardboard is used to frame or support the blister packs. The multilayer seal described herein may be used in a “blister pack” type container for pills. The multilayer seal described herein is used in place of the foil, plastic or a laminate liner of the common blister pack.

Liquid only containers. The multilayer seal may be used with containers for liquids. In one embodiment, the seal may be easily broken with a straw and the liquid aspirated. Prior to consumption, or rupture of the seal, the multilayer seal provides a complete liquid, water and vapor barrier preventing any contamination of the liquid from external sources. A typical example is where the multilayer seal is placed on a small container of juice. Containers of this type are commonly sold with an attached straw, which is removed from the contained and used to break through a designated place in the side of the juice box. The advantage of the multilayer seal is easy perforation. When the multilayer seal described herein is used, straws don't break or bend, as they typically do with currently available devices. Paper and plastic straws work well with this seal. The multilayer seal also prevents bits and/or small pieces of the barrier from entering the straw or liquid and being accidentally swallowed or inhaled by the user, an unpleasant at best and a potentially dangerous side effect when using typical plastic and foil laminate barriers.

Solid and liquid combination containers. The multilayer seal described here is useful where both a liquid and solid are contained and stored adjacent to one another but separated, and later combined by the end user. This can be accomplished without any exposure of the solid or liquid to the outside environment, even after mixing. It is even possible, with the multilayer seal disclosed herein, to use a large, yet relatively weak and frangible pill that is extremely sensitive to water vapors. Humidity must be carefully controlled when such pills are being made or packaged. The humidity of the liquid portion of the container by contrast is often high. A complete vapor barrier is often required in order to maintain the integrity and appearance of the pill and give it a reasonable shelf life. Typically, such a barrier is tough and/or thick and cannot be easily broken, unless resort is made to the use of plungers or sharp implements. In contrast, the multilayer seal provides such a vapor barrier and yet still allows easy and complete rupture when admixing is desired.

The multilayer seal provides for a clean break with no accidental tearing of the seal, which could contaminate the liquid and/or the solid with bits of plastic or foil. The low force needed to rupture the multilayer seal disclosed herein also provides for a minimum of crushing of a solid pill, especially larger and more fragile pills or powders, thus promoting a faster more complete transfer of the pill and without leaving a partially dissolved sticky grainy mass in the bubble where there was once a nicely shaped pill or powder. Special manufacture methods that might be needed to manufacture a more durable pill for use in a blister pack type application are not required when using the multilayer seal.

### General Description of the Multilayer Seal

The multilayer seal, in its most fundamental design, must have at least two layers, a deformation or perforated layer and a layer free of deformation. Here the layer free of deformation is also called the solid layer. Both the deformation and the solid layers can have additional layers. In various aspects shown here, from 2 to 20, 30 or 40 layers are described with particularity and from 2 to 8 layers are shown in the drawings. Most typically, the seal has 3 to 12, or 4 to 8 layers. The number of layers used will depend on the purpose, use and manufacturing conditions. The thickness of the layers will vary depending on the materials used. In general, the deformation layer is thicker than the solid layer. A few examples of some materials and their thicknesses are provided in Table 1. In this document, the singular form of a word, like “layer” and its plural form, “layers” may be used interchangeably. It should be understood that substitutions in materials can be made. If a stronger material replaces a weaker material, then the stronger material will usually be made of a thinner material than the weaker material in order to achieve the same burst strength,

### The Deformation Layer

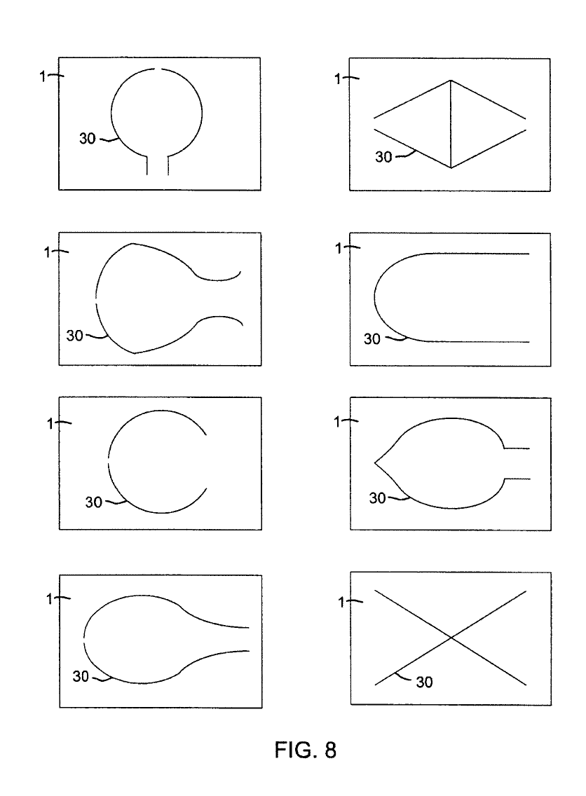

The multilayer seal uses a combination of deformation layers combined with layers free of deformation. The uncut layer is also referred to as the solid layer or layer free of deformation. The deformation layer is cut, or given a fine line of separation, usually entirely through the layer, in a point, line, pattern or shaped cut. Many designs for the deformation may be used. A few of the many possible examples of deformation patterns are shown in FIG. 8. The uncut, solid layer or layer free of deformation is mostly solid without any cuts or perforations, and it is fixed to the deformation layer by any means that creates a liquid and vapor tight seal or bond. The different layers may be sealed, bonded or laminated together by melting, adhesion, compression, fixing, bonding and the like. Adhesion may take place simply because of the nature of the materials used in the layers. In some cases, a layer can be sprayed on, either with use of a pattern made in a stencil or in the case of the layer free of deformation, which is not cut, the layer can be sprayed on with no stencil or pattern needed. The composition of the spray on layer would be chosen or adjusted to make it adhere to the cut layers upon spray application. Other means of manufacture, known to food and pharmaceutical manufacturers, or described in manufacturing trade publications can also be used.

Cutting the deformation layer. The deformation layer, regardless of the actual number of layers or compositions used, must be cut, scarred or perforated in some manner. The deformation can be by any means and this is discussed in more detail in the section titled, “Making the cut,” The deformation may be in the shape of some pattern, the “pattern of the deformation.” The deformation will ordinarily completely penetrate the majority of the pattern of the cut. In some cases, a few gaps or spaces in the fault line will be desired to help keep the pieces of the layers aligned properly. Such gaps are shown in the images on the left side of the page of FIG. 8. The cut in the deformation layer forms the shape of the fault and the facilitated rupturable barrier. This is a line of demarcation, the cut line or the deformation line.

Making the cut. The deformation can be performed in a variety of ways with a variety of tools. One device is a straight blade. The blade is brought down on the material, making a clean cut through the layer or layers. The location and depth of the deformation can be precisely made with a variety of instruments. Another method to make the cut is with a rotary cutter. The location and depth of the deformation can be precisely made with a variety of rotary cutters. Other types of cutters can also be used, laser cutters, water cutters, etc. Any device can be employed as long as it can be used to make a precise cut. With some materials, the cut may not have to completely penetrate the layer.

It is important that the cut be made precisely and very narrow. If the cut is too wide, it will allow the transmission of oxygen and water vapor, which may drastically shorten the shelf of any product contained by the seal. The widest the cut can be and have the seal work is about 0.510 mm. If the cut is too thin, then the barrier will not rupture as it should and the seal will not work properly. The thinnest the cut can be and have the seal work is about 0.002 mm. In another embodiment, the widest the cut should be is about 0.254 mm and the narrowest the cut can be is about 0.012 mm. In another embodiment, the widest the cut can be and have the seal work is about 0.127 mm and the narrowest the cut can be is about 0.025 mm. These are the ranges of the width of the cut line or deformation line for a seal.

The pattern of the deformation may be important depending on the use desired. For straw and liquid applications, the pattern is not very important. In those applications, the shape of the cut could be an “X” or “C” or hinged “C,” “U,” or “H” or whatever, depending on the needs and preference of the user or manufacturer. Any pattern shown in FIG. 8 could be used, in addition to other suitable patterns. In general, the preferred patterns are those that have a continuous piece to hold all the parts of the ruptured seal together in one piece and keep it attached to the remainder of the seal that would still be attached to whatever the seal is attached to, whether that is a bottle container, a pill container or other. The goal is to avoid having bits of the ruptured piece enter the liquid or at any time fall off and otherwise contaminate or mix with any liquids or solids contained by the container or seal. Examples of acceptable deformation patterns are common and many are found in the alphabet. For example, the letters, C, and U make good shapes for use with pills. Hinged “C” may be better with some pills. A straw application can do nicely with a pattern like the letter “X.” A pattern such as an “X” or “C” or hinged “C” or “U” could all be used. Any number of shapes could be imagined and used. For many uses the pattern chosen will be what is referred to here as “open” rather than “closed.” This is mainly in reference to the shape of the pattern of the deformation. Closed lines like “O, P, B, R Q” etc., have shapes where at least a portion of the pattern is entirely isolated by at least a portion of the cut. Consider the loop of the letters “P,” and “R,” the two loops in the letter “B,” and the entire center portion of the letter “O.” These patterns with closed loops are more likely to break free upon or after rupture and possibly contaminate or even plug a straw or the fragment could end up in the liquid. A closed pattern could, however, be accepted or even preferred when used in the solid only mode. Such considerations as plugging a straw or accidental ingestion are considered a low risk when the multilayer seal is used in “blister pack” type devices.

### The Layer Free of Deformation

In this disclosure, one layer is not cut or deformed; this is the layer free of deformation. It is a mostly solid layer, one that is free of the deformation made on the deformation layer, at least free of a deformation made in the same place as in the deformation layer. The mostly solid layer may be called the layer free of deformation, the solid base layer or solid layer or solid base. This layer can be made of one layer or more than one layer. Compositions of the solid layer can vary from 1, 2, 3, 4, 5, 6, 7, 8 or even more layers if the layers are of appropriate thickness and strength. Determining the appropriate thickness and strength of the layer free of deformation is an important aspect. The determination should be routine once the desired parameters are established. A balance between thickness and strength needs to be made. Methods to determine appropriate strength and thickness are provided herein. Different thicknesses and strengths may be required for different applications. The solid layer should be made from material thick enough and strong enough to stop the transmission of vapor and oxygen, yet thin enough to be ruptured. Measurements can be made to determine the thickness of a layer or layers of materials that will rupture as required.

The layer free of deformation serves three main purposes. First, it is a complete seal capable of stopping contaminates from passing through the seal. This leads to good shelf life, and a sterile barrier. Second, the layer free of deformation serves as a gauge to control the burst strength. The deformation layer provides little resistance to breaking. It adds the precise amount of strength to make the seal work properly. The solid layer provides the required strength properties to complete the seal, yet it is weak enough to be broken when a force acts on it. The solid layer also serves as an attachment layer to stick the deformation layer to different substrates. Although an adhesive product can be used to attach the seal, having compatible plastics between the seal and housing is better for attaching with heat staking, ultrasonic welding, induction welding or other such attachment techniques.

The first purpose of the layer free of deformation is to provide an impervious barrier. The solid layer can serve as a good oxygen and water vapor barrier. Ordinarily, when a layer of a seal is cut, or broken, the integrity of the seal is breached and it becomes an incomplete barrier. Incomplete barriers or seals allow the flow of gas, liquid or small particles through the break in the seal. Materials like water, water vapors, and oxygen can break down and destroy a pill or whatever the seal is intended to contain. Bacteria and viruses can also pass through a cut or broken seal, leading to contamination. By adding the solid layer to the deformation layer, it creates a complete seal. This seal will hold back liquids, gasses, and other contamination.

The multilayer seal has good oxygen and vapor barrier qualities. Oxygen and water vapor break down food products and lead to a short shelf life. Much effort has gone into creating films that lengthen shelf life. Metallic foils are good barriers, but so are other materials such as: Aclar, PVdC, EVOH, Nylon, PET and other materials. However, these materials are thick and strong and are often difficult to break. Typically, one would think of selecting a compound with a low Oxygen Transmission Rate as a solid layer because two critical measures of shelf live are oxygen transmission rate (OTR) and water vapor transmission rate (WVTR). Table 1 provides the Typical Oxygen Transmission Rates (OTR) for various plastics that one might consider using for this disclosure.

TABLE 1
Typical Oxygen Transmission Rates
per 1 mil thickness 100 sq. in area at 77°

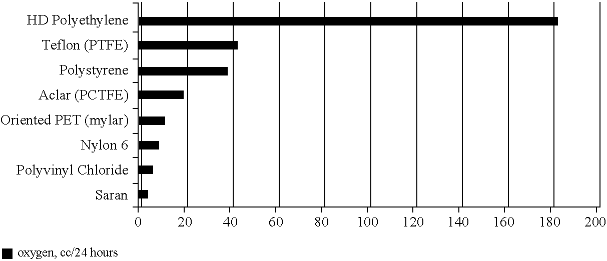

TABLE 2
Table 2 provides the Typical Water Vapor Transmission Rates
(WVTR) for various plastics that one might consider for
this disclosure.
Typical Water Vapor Transmission Rates
per 1 mil thickness and 100 sq. in

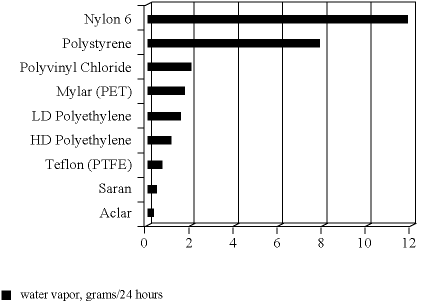

Normally when selecting material for a solid layer for a seal protecting solids and pills, the material should have two important properties, low oxygen transmission and low water vapor transmission. This is why foil laminated with plastic is often used for seals and makes such a good barrier. Foil plastic laminates typically have an oxygen transmission rate and a water vapor transmission rate of close to zero. But foil plastic laminates are tough and difficult to break. Table 1 above, shows the oxygen transmission rate for PE is very high. It indicates the rate for HD polyethylene is over 160 cc/one mil thickness and 100 square inch area at 77 degrees F. The table shows the transmission rate for LD polyethylene is 500 cc/one mil same conditions as above. This high rate of oxygen transmission would normally rule out the use of PE for the solid layer. To protect a pill and provide good shelf life, the oxygen transmission rate should be as low as possible, with levels much less than a tenth of a gram per 24 hours. Surprisingly, we have found that PE is the best material for use when the seal is made according to the descriptions provided herein.

Another material with a fairly high rate of water vapor transmission is PET. While Table 1 shows it does not have nearly as high a transmission rate as PE, it is still in the range of about 5 cc/one mil thickness and 100 square inch area at 77 degrees F. Normally, this level of water vapor transmission would be considered too high to protect a pill or solid, and could not be used in previously known seals. The logical choice would be Saran, which has the lowest oxygen transmission rate. But even Saran would transmit too much oxygen and be too tough to break under normal conditions.

The other important factor for shelf life is water vapor transmission shown in Table 2. Table 2 shows once again that PCTFE or Aclar, followed by Saran are the best materials to select if one is seeking a material with a low rate of transmission of water vapor. PE, both HD, LD as well as PET (Mylar) are poor choices and placed in the middle of the Table. Even HDPE with a rate of about 0.5 or 0.4 grams of water vapor/24 hours/1 mil thickness and 100 square inch area at 100 degrees F. and 90% Relative Humidity, should be considered a rather poor choice because it would allow damaging water vapor to rather quickly reach the solid or pill. What one finds with water vapor barriers are that the thicker the material, the better the barrier. Transmission rates can drop by half as the thickness of the material doubles. Unfortunately, thicker materials are also more difficult to rupture. The proper materials must be selected for a multilayer barrier of the type described here to work.

Surprisingly, we have found that with the system developed and described here, PE and PET are the only two useful materials that can be used for the solid layer, or layer free of deformation.

The layer free of deformation also provides an attachment layer. Different adhesives are available to attach the multilayer seal to the housing. For example, if the seal is used in a closure and attached to a plastic bottle, it could be used by a filling company that had welding capabilities on their filling lines. By making the layer free of deformation from the same material as the bottle, the filling company can attach the multilayer seal to their bottles with little or no capital expense. For an HDPE bottle, or housing, a PE film could be used as the outer most layer of the layer free of deformation. For PET, or PETE bottles, a PET film could be used.

In order to burst the multilayer seal, a pill, powder, or device like a straw or the pill itself is pushed through the seal. Pushing a solid through the multilayer seal causes the layer free of deformation in the seal to stretch slightly, and then break. Using a material with a high tensile strength could lead to a multilayer seal that will not break easily. High tensile strength materials need to be thin in order to achieve a burstable seal.

Burstability, which can be measured, refers to the ease with which a seal can be broken. Burstability can be measured. One way to measure burst strength is to install the multilayer seal into the finished product. A seal that is working properly should break and cleanly dispense a pill or easily allow a solid to be pushed through the seal.

Another way to test for burst strength is by hitting the multilayer seal with a controlled force to test for breaking. Tests of this type were performed using a pneumatic cylinder assembly. The pneumatic cylinder assembly consisted of a clamp to hold the multilayer seal taught and a pneumatic cylinder with a I″ bore. The cylinder rod was set up against the seal and the pressure increased until the seal broke. A break was not a pin hole or slight tear, but a large tear, over 50%, of the seal. Table 3 shows the pressure it took to break a seal using the pneumatic cylinder using different thicknesses of LDPE and 1.5 MIL HDPE and LLDPE.

TABLE 3
LDPE Burst Strength

| Material | Thickness (inches) | Lbs to burst (PSI) |
|---|---|---|
| LDPE | .0015 | 9.3 |
| LDPE | .0020 | 11.7 |
| LDPE | .0030 | 26.0 |
| HDPE | .0015 | 10.6 |
| LLDPE | .0015 | 8.9 |

Checking the burst strength of the multilayer seal is important to confirm the multilayer seal works properly. For example, if the multilayer seal is being used to dispense a pill, it is very important that the seal breaks before the pill breaks. If one seeks to push a straw through the seal, the seal must break before the straw buckles or breaks. The multilayer seal must have the proper strength in order to function properly.

The multilayer seal must also be strong enough to resist breaking due to slight variations in pressure. Testing strength for pressure changes can be done using a Water Entry Pressure (WEP) Test Method. Table 2 shows the WEP for multilayer seals with different solid layers. The testing device used for WEP consists of a pressurized fixture that forces water against the seal until a pin hole is formed. A pin hole in a seal can allow contamination to pass the seal barrier.

TABLE 4
Water Entry Pressure for Various Solid Layers

| | | Average Water Entry |
|---|---|---|
| Material | Thickness (inches) | Pressure (PSI) |
| LDPE | .0015 | 8.4 |
| LDPE | .0020 | 10.2 |
| LDPE | .0030 | 16.4 |
| HDPE | .0015 | 14.3 |
| LLDPE | .0015 | 5.8 |

The solid layer or layer free of deformation can be made of one layer or a combination of layers. It could be made of 1, 2, 3, 4, 5, 6, 7, 8, 9, 10 or a multiplicity of layers as long as the Burst Strength and WEP are suitable for the application. Table 3 and Table 4 show measurements made with PE, one of two preferred materials that can be used to make the solid layer. A wide variety of PE types and styles can be used in the solid layer for the seal. By matching the thickness and tensile strength, it is possible to obtain a suitable burst strength and WEP. PE has a relatively low tensile strength; a thickness of over 1 mil can be used. When using PET, a 1 mil or even ½ mil film should be used because of the high tensile strength.

It is possible to combine plastic films to provide different characteristics. For example, a two layer system can consist of HDPE and LDPE. The 2-layer film has to have a thickness range that gives at least about 3.0 PSI for a WEP and no more than 50.0 PSI for burst strength. Although many combinations work, a 1 mil HDPE and 1 mil LDPE should work well. A three layer system could use LDPE, HDPE, and LDPE. Using a three-layer system, again, the WEP should be at least about 3.0 PSI and the burst strength should be no more than about 25.0 PSI. A ½ A mil LDPE, 1 mil HDPE, and ½ mil LDPE is one such combination found to be within this range. This embodiment is especially useful because a wide variety of layers and materials can be used.

The following ranges for the WEP and Burst strength are provided. When a pill dispensing application is desired a facilitated rupturable seal having a thickness that gives: 1) an Average Water Entry Pressure (WEP) of about 3.0 to 20.0 PSI and a burst strength of about 4.0-25.0 PSI, 2) an Average Water Entry Pressure (WEP) of about 7.0 to 12.0 PSI and a burst strength of about 7.0-10.0 PSI is disclosed, and 3) an Average Water Entry Pressure (WEP) of about 9.0 to 10.0 PSI and a burst strength of about 8.0-9.0 PSI is disclosed.

The layer free of deformation is attached the deformation layer. Adhesives or energy can be used to attach the layers. The layers can be easily attached by melting using such devices as a heat staking tool, ultrasonic tool, or induction welding tool. Alternately, the layer free of deformation can be sprayed onto the deformation layer to provide a layer free of deformation upon drying. Alternately, adhesion can take place simply because of the nature of the materials used in the layers. Adhesives come in different grades, like food grade or medical grade, which can be used depending on the application.

When attaching the layers together, the layers should completely bond or seal. A complete seal is one that has at least one solid layer, or layer free of deformation, completely adhered to a deformation layer. A complete seal, upon breaking, will not allow any of the solid layers to break free from the deformation layer. It is important that the layer free of deformation stays attached to the deformation layer in order to control the break so that no parts or pieces of the multilayer seal contaminate the associated solids or liquids, including any solutions, pills, powders, gels or syrups that may be involved.

Attaching the multilayer seal to a device. Although adhesives work well to attach the multilayer seal to various devices, such as bottles, juice boxes or pill dispensers; dispensing adhesives can be difficult and the capital equipment expense can be quite high. Other attachment techniques are more cost effective. Plastic welding is one such way that the multilayer seal can be attached. Using ultrasonic welding, heat staking, and induction welding are some examples of plastic welding techniques. Depending on the application and the installer of the multilayer seal, welding may be a cost effective attachment technique. In order to optimize the welding process, it is best to have similar materials welded together. For example, if the seal was being used in a closure and attached to a plastic bottle, it could be sold to a filling company. Filling companies are usually familiar with induction welding.

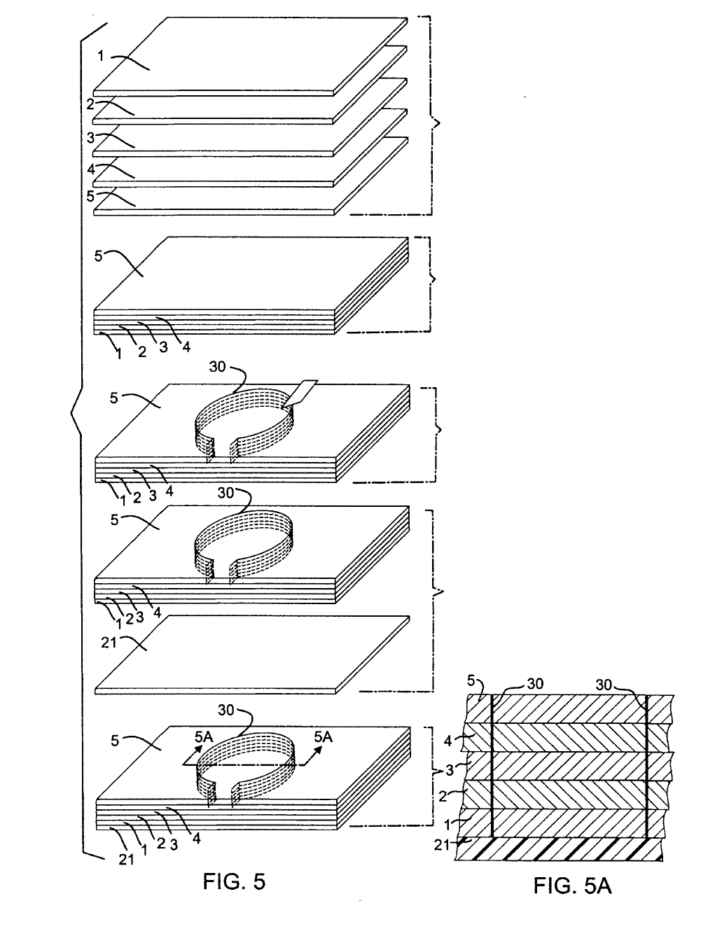

Types of layers. Examples of various layers and materials that could be used for the layers or zones of materials are provided. A four layer multilayer seal may have a deformation layer comprised of three type of layers, those layers can be consider as, 1) a backing layer, 2) a foil layer, and 3) a melt layer. A five or six layer multilayer seal may have a deformation layer comprised of four types of layers; those layers might be considered as 1) a backing layer, 2) a foil layer, 3) a barrier layer, and 4) a melt layer. Below, in Example 1, and FIG. 5, a six layer multilayer seal is shown having two backing layers, one foil layer, one barrier layer (PVdC), one melt layer, all being deformation layers, plus one solid layer of PE. Additional details of Example 1 are found below.

The orientation and compatibility of the layers. The multilayer seal is typically made of materials compatible with sealing with the device with which it is to be used. Materials compatible with the inner most and outer most deformation layers or solid layer(s), and with the material, to which the seal will be bonded to, are likely to be used. The melt layer should be compatible to that with which it melts. In Example 1, the bottom of the deformation layers becomes the so called “melt layer.” In Example 1 the melt layer is made of medium density PE (MDPE). This is the layer in FIG. 5 that rests against and is joined to the solid layer (bottom layer (#1) in FIG. 5). This melt layer is made of low density PE. (Note the top layer in FIG. 5 (#5) is made of PET, and this material could have been used as the melt layer if desired. In case, the outer most layer or melt layer of the deformation layers may be used to join the solid layer to the deformation layers. The multilayer seal is then joined to the container. Compatibility of materials, seal and container, makes attaching the seal to a container simple. Other materials can be used for the melt layer, the top or the bottom of the deformation layers. Medium density PE for a melt layer has proven to work well. It adheres well to the solid layer and then the solid and melt layers can easily be combined and made to bond to the device that uses the multilayer seal.

The compatibility of the various layers and especially the outer most layers of the multilayer seal allows for a solid welding of the various pieces and provides good shelf life with excellent containment of both liquids and solids. PE and various forms of PE are commonly used. Choosing a melt layer of PE for the solid layer allows the bubble or blister to be readily, easily and durably fixed or welded to the multilayer seal.

The composition of the layers.

The deformation layer may be made from a variety of materials and a variety of layers. Here we also specifically describe 1, 2, 3, 4, 5, 6, 7, 8, 9, 10, 11 and 12 separate layers for the deformation layer. These layers are commonly made from: PE, foam PE, PVC, PVdC, foil, PET, PETE, other Polypropylenes or other Polyolefin's can be used. Combinations of foil plus some type of PVdC or PE are commonly used because energy can be easily transmitted to the foil in a controlled manner, thus melting an associated film of plastic such as PVdC or PE, which can be used to create a nice bonded barrier. The deformation layer can be made of foil. The foil layer can be of any suitable thickness. Foil layers of thickness from 0.006 to 0.5 mm will work, depending on the application needed and the other materials used. Foil layers of thickness from 0.010 to 0.130 mm will work, depending on the application needed and the other materials used. Foil layers of thickness from 0.012 to 0.026 mm will work, depending on the application needed and the other materials used.

The solid layer or layer free of deformation should be made of either PE or PET. The PE may be either foam PE, HDPE, LDPE or LLDPE, or other forms of PE. If PET or Polyethylene terephthalate is used, it may be Mylar or that sold under other brand names.

Variations and substitutions can be made to both the materials and layers described for the cut layer. The size of the cut, the inside diameter across the cut (line to line widest points), can vary from 0.05 inch to over an inch if desired. The number of layers of either the deformation layer or the solid layer can vary, but typically the deformation layer is thinner and uses one or two layers that are made to rupture easily. The thickness of the solid layer or layers determines how easily the seal ruptures. As shown in FIG. 1, the device can be made with just two layers, a solid and a deformation layer. PE can be used for either or both of these layers.

The melt layer is optional, adhesives could be used. Spray-on materials can be used for the solid layer. If a melt layer is used, it can be composed of various materials.

The thickness of the deformation or cut layer. An important aspect is the strength of the multilayer seal in combination with the ease with which the seal can be ruptured along the fault line. How easily this rupture is made can be controlled by varying the thickness of the solid barrier layer. Since the deformation layer is weakened, its role in preventing rupture is not controlling, rather the deformation line facilitates rupture and the solid layer controls the rupture. This greatly facilitates manufacture and allows for quick optimization of the multilayer seal for whatever product will be used. For example, a hard small pill might require a thicker solid layer than a large fragile pill. A powder solid might require a thinner more brittle solid layer.

Fixing or bonding of the layers. At least two of the layers must be fixed to each other. One method of fixing the layers is to “melt” the layers together. This melting is known to one ordinarily skilled in the art and involves controlled heating at temperatures that range from about 150 to about 600 degrees F., but are often done between 280 and 450 degrees F. and are typically done at about 400 degrees F. The fixing of the layers can also be accomplished chemically, such as with glues and other means. Separation of the individual layers from each other should be avoided.

Alignment of the layers. Of importance in the manufacture of the multilayer seal is the proper alignment of the deformation layer and the solid layer. The proper alignment occurs when there are no areas of overlap and no areas of excessive width of the deformation or fault line. When the fault line is viewed from above, it should appear of approximately uniform width, and there should be no large portions of the deformation layer that overlap. One method for creating this uniform appearance is to handle the material carefully, because once cut, greater movement of the deformation layer is possible. Another technique to control movement of the deformation layer after cutting is to leave a few “uncut spots” in the cut line, that is, one or more interruptions or gaps are left in the deformation line. Such a line with such “gaps” may also be called or considered a type of perforated line. Typically, the perforations are not regular; the cut portion of the line is usually greater than the uncut spots. The “attachment” points or the cut line with uncut gaps can function like a stencil that holds the area within the deformation in the proper position. This is shown in the images on the left side of FIG. 8. One gap per image is shown, but additional gaps could be used at the preference and option of the manufacturer. The presence of the uncut spots or gaps makes the deformation layer stay in one place, so that the material of the cut layer does not move relative to either the other regions of the cut layer or the uncut layer. For most embodiments, the multilayer seal will not have a cut line with some places having overlap and other places with excessive width in the cut line. One method to create these gaps or uncut spots is to put a small notch in the blade that cuts the deformation layer. If a notch or interruption is put in the blade doing the cutting, it will leave one or more places in the cut line that do not get cut and instead become a gap in the deformation line and act as an attachment point that keeps the deformation layer in place. Generally, the gaps, if any, will be shorter than the cuts in the deformation layer.

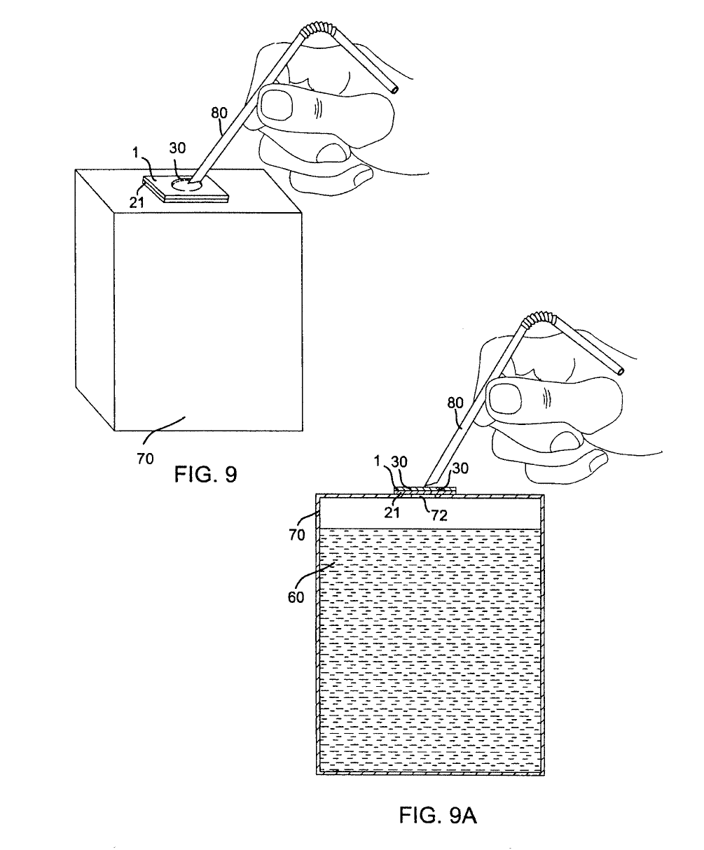

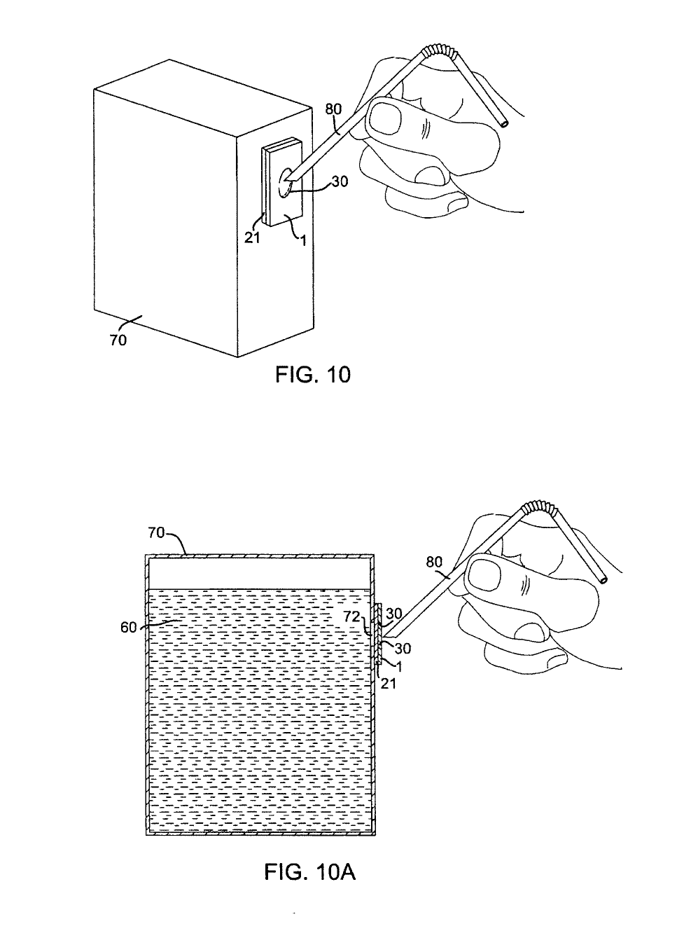

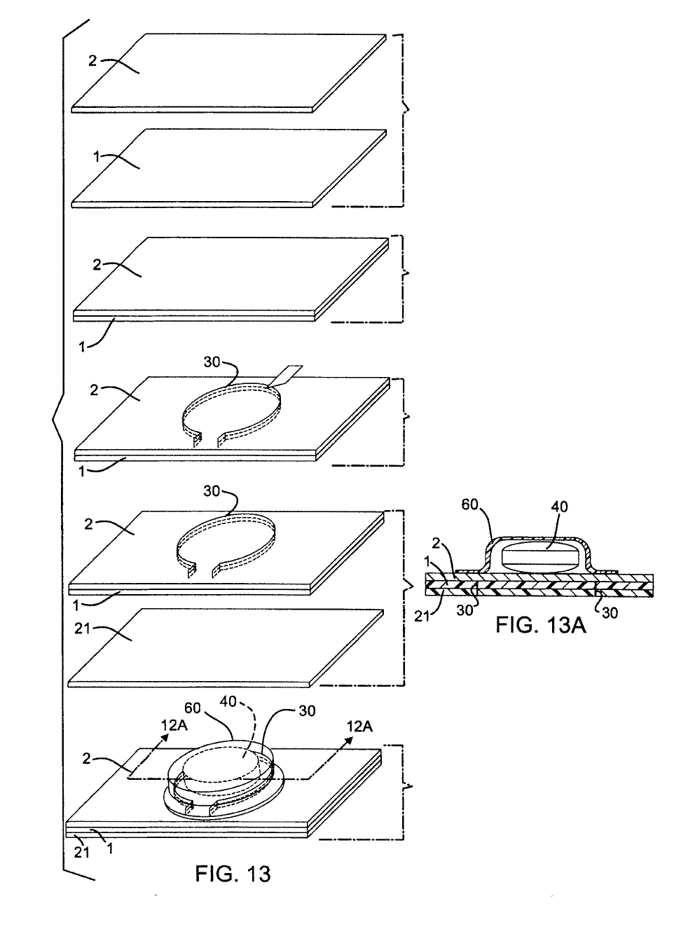

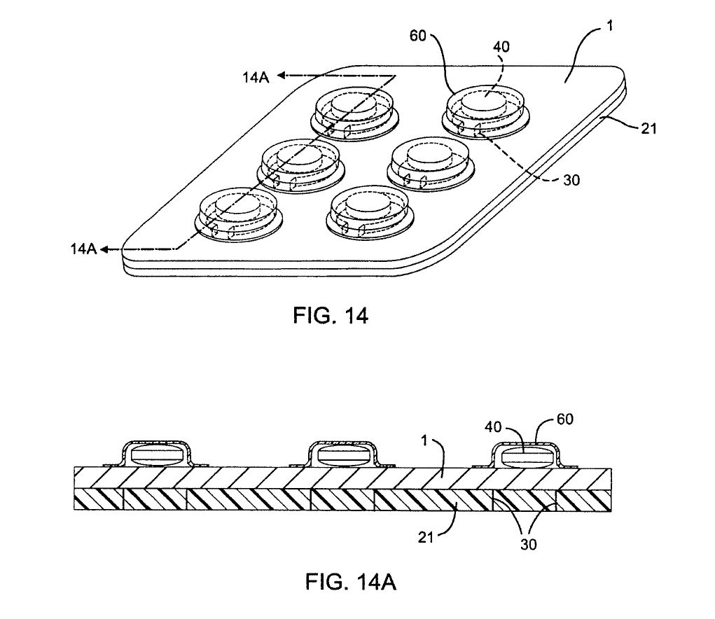

The different sides and uses of the multilayer seal. The multilayer seal has two sides, a solid side and a deformation or cut side. Either the solid side or the deformation side can face either toward or away from the solid or the liquid. One can also refer to the inside and the outside of the seal when for example it is used with a container having an inside and an outside. See for example the boxes in FIGS. 9 and 10 where the inside of the container has a liquid and FIGS. 13 and 14 where the inside of the seal has a pill and the outside of the seal is where the pill is ejected. Which side of the seal faces either the inside or outside depends on the container and the application involved. The multilayer seal as described herein and as shown in FIGS. 1-7 has the deformation layer on top. This orientation is shown just to provide a consistent view for the reader. The descriptions here, and in the Examples below, will often refer to this orientation, that is, cut side on top, solid layer on bottom, but it should be apparent and understood that the multilayer seal can be oriented in any direction, up down, side to side, and flipped over to any position, with either side used in the “up” or “down” or “inside” or “outside” position. Either end or side of the multilayer seal can be joined to other materials depending on the use desired. It is purely for convenience and to avoid confusion that this document refers to the top and bottom of the multilayer seal.

The following orientations, provided below, are merely illustrative and should not be considered limiting, orientation can change depending on the application and materials used.

When the multilayer seal is used in the solid only dispenser or “blister pack” type of application, the pill or tablet may rest against the deformation layer. In reference to FIGS. 1-7, the solid, powder, pill, capsule, tablet, etc. (here “pill”) would rest on the cut layer. The pill would also be covered with another layer of plastic, the “bubble top,” that would be melted to the top layer. See FIGS. 13 and 14 for a sample example illustration. Any type of solid can be used, such as a pill, powder, grains, dust, pellets, coated materials, nanoparticles and the like.

When the multilayer seal is used in the liquid only type of application, it is preferred to have the straw pierce the top of the deformation layer. In reference to FIGS. 9 and 10, the straw would come from above, first contacting and then piercing the cut layer(s), then the solid layer(s) and finally going into the liquid.

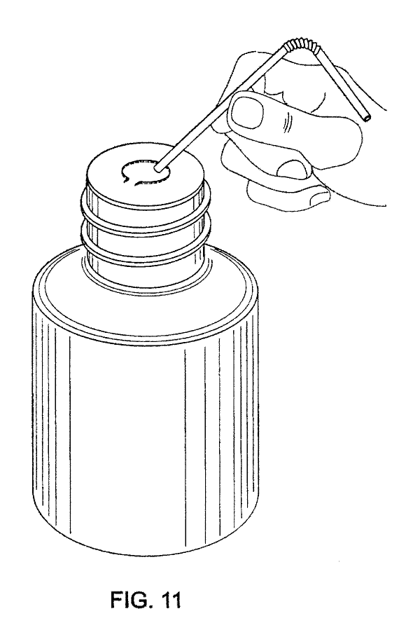

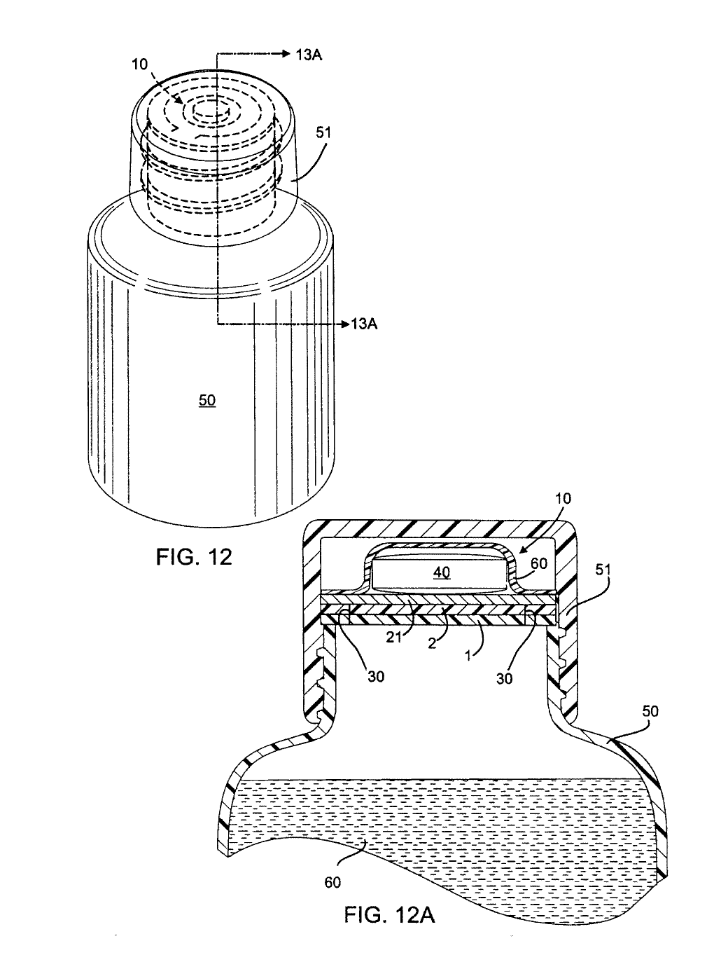

When the multilayer seal is used in the solid and liquid combination application, it is preferred to have the pill or tablet resting against the deformation layer. In this type of application, one would visualize the images in FIGS. 1-7, to be flipped over, with the cut layers at the bottom of the page the solid layer on top. The pill would then sit on top of the seal. The pill could be covered with a layer of plastic or “bubble top” over the top of the multilayer seal. The bubble top covering the pill can also be covered with a larger protective cap that can be unscrewed or snapped off. Shown in FIG. 11, with cap off. In this orientation, the plastic bubble top would be welded to the solid layer, since the solid layer is now on top and next to the pill. The liquid would be below the seal, under the cut layer. Shown in FIGS. 12 and 12A with cap on. To rupture the multilayer seal and release the pill, a finger could push down on top of the bubble over the pill, forcing the pill down, rupturing the multilayer seal. The pill will be pushed against the solid layer, down past the deformation layer and then drop neatly into the liquid.

Numbered description of the disclosure.

1. A facilitated rupturable seal comprising a deformation layer and a layer free of deformation, wherein the deformation layer is comprised of either PE or PET and comprises one or a multiplicity of layers; wherein the layer free of deformation comprised of one or a multiplicity of layers; wherein the deformation layer and the layer free of deformation are combined and fixed to each other, wherein the combined deformation layer and a layer free of deformation form a moisture and vapor resistant barrier; wherein the seal has an overall thickness that withstands an Average Water Entry Pressure (WEP) of about 3M to 25.0 PSI and has a burst strength of about 20-50 PSI, an Average Water Entry Pressure (WEP) of about 4.0 to 20.0 PSI and has a burst strength of about 30-50 PSI or an Average Water Entry Pressure (WEP) of about 5.0 to 17.0 PSI and has burst strength of about 40-50 PSI.

2. A seal of number 1, wherein the deformation layer or cut layer is comprised of PE and the layer is comprised of at least a melt layer. 3. A seal of number 1, wherein the deformation layer or cut layer is comprised of PET and has at least a melt layer. 4.

A seal of number 2, wherein the deformation layer is comprised of a melt layer and a backing layer. 5. A seal of number 3, wherein the deformation layer or cut layer is comprised of a melt layer and a backing layer. 6. A seal of number 2, wherein the deformation layer is comprised of a melt layer, a backing layer, and a foil layer. 7. A seal of number 3, wherein the deformation layer is comprised of a melt layer, a backing layer, and a foil layer. 8. A seal of number 2, comprising a melt layer, a backing layer, a foil layer, and an internal barrier layer. 9. A seal of number 3, comprising a melt layer, a backing layer, a foil layer, and an internal barrier layer.

10. A facilitated rupturable seal comprising a deformation layer and a layer free of deformation, wherein the deformation layer may be comprised of a multiplicity of layers and is comprised of a complete cut line through the layer; wherein the cut line has a thickness of about 0.002 to 0.510 mm in width; wherein the layer free of deformation may be comprised of a multiplicity of layers; wherein the deformation layer and the layer free of deformation are combined and fixed to each other, wherein the combined deformation layer and layer free of deformation form a moisture and vapor resistant barrier, wherein the layer free of deformation is comprised of either PE or PET and comprises one or a multiplicity of layers; wherein the deformation layers are comprised of PE, PET, PCTFE, Saran, PTFE, PVC, PS, Nylon, PVdC or foil and combinations thereof.

11. A seal of number 10, wherein the deformation layers are comprised of: PE, PET, PCTFE, PTFE, PVC, PS, PVdC or foil and combinations thereof, 12. A seal of number 11, wherein the deformation layers are comprised of: PE, PET, PVdC or foil and combinations thereof. 13. A seal of number 10, wherein the seal has pattern and the pattern of the deformation is an open pattern, or any of the shapes in FIG. 8, or in the shape of the letter “C” or a hinged “C” shape, or where the pattern is a “U” or a double triangle shape. 14. A seal of number 10, wherein the seal is comprised of 4, 5 or 6 layers. 15. A seal of number 14, wherein the seal is made four layers, wherein the solid layer is made of PE; two of the deformation layers are made of PE; one of the deformation layers is made of foil. 16. A seal of number 14 wherein the seal is made of four layers, comprising a solid layer made of PE; the solid layer made of PE is made of low density PE; two of the deformation layers are made of PE, one of the deformation layers is made of foil; one of the deformation layers made of PE is made of medium density PE.

17. A seal of number 15 wherein the seal comprises four layers, wherein the four layers are comprised of: a solid layer made of PE; the solid layer made of PE is made of low density PE; two of the deformation layers are made of PE; one of the deformation layers made of PE is made of medium density PE; the deformation layer made of medium density PE is next to the solid layer of PE; one of the deformation layers is made of foil. 18. A seal of number 14 wherein the seal comprises five layers, wherein the five layers comprise: PE, PET, foil and PVdC or a combination thereof. 19. A seal of number 14 wherein two of the five layers are comprised of PE, and the other three layers are comprised of compounds selected from PET, foil and PVdC. 20. A seal of number 24 wherein the seal has five layers, comprising; the solid layer made of PE; two of the deformation layers are made of PE or PET; one of the deformation layers is made of foil; one of the deformation layers is made of PVdC. 21. A seal of number 20 wherein the seal has five layers, comprising; the solid layer made of PE, the solid layer made of PE is made of low density PE; one of the deformation layers is made of PET; one of the deformation layers made of medium density PE; one of the deformation layers is made of foil and one of the deformation layers is made of PVdC.

22. A seal of number 20 wherein the seal has five layers, comprising; the solid layer made of PE; the other four layers are deformation layers made of PE, PET, foil; and one of the deformation layers is made of PVdC. 23. A seal of number 20 wherein the seal has five layers, comprising; the solid layer made of PE; the other four layers are deformation layers made of PE, PET, foil; and one of the deformation layers is made of PVdC; and the deformation layer of PE is next to the solid layer of PE. 27. A seal of number 14 wherein the seal is made six layers, wherein the six layers comprise six layers made from compounds selected from PE, PET, foil, PVdC and polyolefin and combinations thereof.

28. A seal of number 27, wherein the seal is made of six layers; comprising a seal with; two of the six layers made of PE, and four layers are made of materials selected from; PET, foil, PVdC and polyolefin; wherein; one of the PE layers is the solid layer. 29. A seal of number 28, wherein the seal is made of six layers; comprising a seal with; two of the six layers made of PE, and the other four layers are deformation layers made of materials selected from PET, foil, PVdC and polyolefin; wherein one of the PE layers is the solid layer; wherein the other PE layer is a deformation layer adjacent to the solid PE layer.

30. A seal of number 1 wherein the facilitated rupturable seal is incorporated into a juice box and adapted for rupture with a straw. 31. A seal of number 1 wherein the facilitated rupturable seal is incorporated into a pill dispensing card and adapted for rupture with hands or fingers to release said pill. 32. A seal of number 1 wherein the facilitated rupturable seal wherein the facilitated nipturable seal is incorporated into a combination solid and liquid container and allows for rupture by pressing the pill through the seal into a liquid.

33. A facilitated rupturable seal comprising a deformation layer and a layer free of deformation, wherein the deformation layer is comprised of five layers; wherein the layer free of deformation is comprised of one layer; wherein the deformation layer and the layer free of deformation are combined and fixed to each other, wherein the combined deformation layer and layer free of deformation form a moisture and vapor resistant barrier; wherein the deformation layer comprises: five layers having a deformation; wherein: the deformation is in the shape of a pattern; the deformation layers are stacked on top of one another, wherein one deformation layer is made of PE, made of medium density PE (MDPE); wherein the stacked layers are in the following order: second deformation layer, made of PVdC or PET; third deformation layer made of foil; fourth deformation layer made of polyolefin; fifth deformation layer made of PET; wherein the layer free of deformation, is made of low density PE (LDPE) with a thickness of about 0.05 mm; and wherein the combined thickness of the deformation layers is about 0.25 to 0.30 mm thick.

### EXAMPLES

The descriptions provided above allow one to make and use the full disclosure. The following examples and drawings are intended to further describe and illustrate the disclosure without being limiting in any way.

Example 1 is shown in FIG. 5, which shows a six layer seal. Example 1 is made from a substance given the brand name “FS1-19” available from Selig Sealing Corp., but similar materials are available from other suppliers. FIG. 5 shows the cut going through all five layers of the FSI-19. The five layers of FSI-19 make up the deformation layer.

The top two layers, shown in FIG. 5 may be described as “backing layers.” The first, or top layer (1), in FIG. 5, which is a layer of PET; below that, the second layer (2) is a layer of white polyolefin, the polyolefin is either PE or PP, it could be PE foam; these top two layers are referred to as “backing.” In this example, together they are 0.1778 mm thick. These first two layers (1 and 2), provide physical support and provide some barrier to vapors and liquids.

The third layer, (3) just below the top two or backing layers is a layer of foil. In this example, it is 0.0254 mm thick. The foil layer is also a barrier layer that provides strength and vapor resistance to the seal. Foil layers can be made of aluminum, but they can be made of other materials such as tin, copper, bronze, gold or other flexible metallic materials.

The fourth layer (4) is an internal barrier layer. It is composed of a polyolefin derived from PVC. It acts as an internal barrier and adds strength to the seal. In this example, it is 0.0254 mm thick.

The fifth layer (5) is a layer of medium density PE (MDPE). This layer of medium density PE is called the “melt layer” or “heat seal.” In other embodiments, the melt layer or heat seal could be the top layer. It is not necessary that it melt, other methods of bonding could be used.

The five layers described above are cut in a selected pattern, in this case a “C” with a hinge. See FIG. 8 for an overhead view of the pattern of the deformation for Example 1, and FIG. 5. Other suitable patterns are also shown in FIG. 8. In Example 1, the size of the deformation, inside diameter across the deformation (line to line widest points), is about 20 mm across the deformation, which is suitable for a large pill in either the solid only application, or the solid liquid combination applications. The five deformation layers of the deformation layer are then welded to the solid layer (21).

The solid layer is made of low density PE. In this example, the solid layer is 0.051 mm thick. With similar materials, the thickness can vary from about 0.020 to about 0.080 mm. The thickness can be optimized depending on what is desired by the end user or manufacturer.

Example 2 is similar to Example 1, with reference to FIG. 5, only a seal is used in the liquid only container mode. In Example 2, PE is used to make the bottom deformation layer, or melt layer and shown as number (21) in the Figures. In this example, a low density PE (LDPE) is used for both the solid layer (21) and the outside layers of the blister cover or plastic bubble, shown as number (60) in the Figures. The PE is then easily bonded to the last or bottom layer of the deformation layer number (5) in FIG. 5, the melt layer, because it too is made of PE, in this case, medium density PE or MDPE.

Example 3 is notional and is similar to Example 2, only the seal is used in the solid/liquid container combination mode. In this mode, unlike the solid only and liquid only modes, the pill sits against the solid layer. The pill is then covered with a material compatible to the solid layer. This covering becomes the bubble or blister. In Examples 2 and 3, high and low density PE (LDPE) can be used. The only difference between Example 2 and 3 is the orientation of the seal in relation to the pill. In Example 3, the pill rests against the solid layer and the deformation layer faces the liquid.

Examples 4-6. Examples 4-6 are notional and mirror Examples 1-3, only different materials for the deformation layers are used. In Examples 4-6, material used for the deformation layers is “FSM-1,” also available from Selig. FSM-1 has similar components as FS1-19, described in Examples 1-3, with the only difference being that the “barrier layer,” see the fourth layer from the top (4) in FIG. 5, is made from PET rather than PVdC. Examples 4-6 have the same suitable rupturable properties as Examples 1-3.

Examples 7-12 are notional and take the seals and descriptions of examples 1-6 and apply the seal to liquid container for use with straws. See FIGS. 9 and 10. The seal can be positioned so that it sits above the liquid or in and against the liquid. The orientation of the seal can be either side facing either in or out.

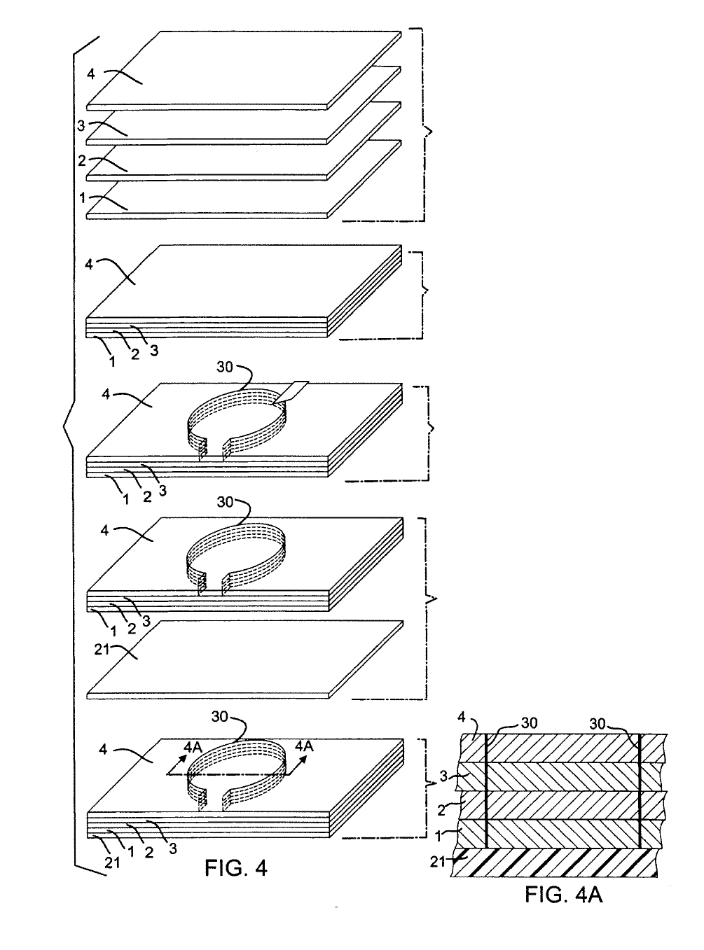

Examples 13-24 are notional and are described by any of the seals above only using a five layer seal as shown in FIG. 4 instead of the six layers described in Examples 1-12. Examples 13-24 use the same materials as described in Examples 1-12 except that on of the two backing layers described in Example 1, is not used with Examples 13-24. The burstability of the seal in Examples 13-24 will not be significantly different from Examples 1-12.

This disclosure has been described as having exemplary processes and is intended to cover any variations, uses, or adaptations using its general principles. It is envisioned that those skilled in the art may devise various modifications and equivalents without departing from the spirit and scope of the disclosure as recited in the following claims. Further, this disclosure is intended to cover such departures from the present disclosure as come within the known or customary practice within the art to which it pertains.

What is claimed is:

1. A facilitated rupturable seal comprising a deformation layer and a layer free of deformation,
wherein the deformation layer is comprised of either PE or PET and comprises one or a multiplicity of layers;
wherein the deformation layer and the layer free of deformation are combined and fixed to each other,
wherein the combined deformation layer and layer free of deformation form a moisture and vapor resistant barrier;
wherein the seal has an overall thickness that withstands an Average Water Entry Pressure of about 3.0 to 25.0 PSI and has a burst strength of about 20-50 PSI, an Average Water Entry Pressure of about 4.0 to 20.0 PSI and has a burst strength of about 30-50 PSI or an Average Water Entry Pressure of about 5.0 to 17.0 PSI and has burst strength of about 40-50 PSI.

2. The facilitated rupturable seal of claim 1 wherein the deformation layer is a cut layer comprised of PE and has at least a melt layer.

3. The facilitated rupturable seal of claim 1 wherein the deformation layer is a cut layer comprising PET and has at least a melt layer.

4. The facilitated rupturable seal of claim 3, wherein the cut layer comprises a melt layer, a backing layer, and a foil layer.

5. The facilitated rupturable seal of claim 1, wherein the deformation layer comprises a melt layer, a backing layer, and a foil layer.

6. The facilitated rupturable seal of claim 1, wherein the deformation layer comprises a melt layer, a backing layer, a foil layer, and an internal barrier layer.

7. The facilitated rupturable seal of claim 1, wherein the deformation layer comprises comprising a melt layer, a backing layer, a foil layer, and an internal barrier layer.

8. The facilitated rupturable seal comprising a deformation layer and a layer free of deformation,
wherein the deformation layer has a multiplicity of layers and a complete cut line through the deformation layer; wherein the cut line has a width of about 0.002 to 0.510 mm;
wherein the layer free of deformation includes a multiplicity of layers;
wherein the deformation layer and the layer free of deformation are combined and fixed to each other,
wherein the combined deformation layer and layer free of deformation form a moisture and vapor resistant barrier;
wherein the layer free of deformation comprises either PE or PET and comprises one or a multiplicity of layers;
wherein the deformation layers are comprised of PE, PET, PCTFE, Saran, PTFE, PVC, PS, Nylon, PVdC or foil and combinations thereof.

9. The seal of claim 8, wherein the deformation layers are comprised of: PE, PET, PCTFE, PTFE, PVC, PS, PVdC or foil and combinations thereof.

10. The seal of claim 9, wherein the deformation layers are comprised of: PE, PET, PVdC or foil and combinations thereof.

11. The seal of claim 8, wherein the seal has a pattern of the deformation that is an open pattern in the shape of a spoon, a letter X, a spade, a letter “C,” a hinged “C” shape, a letter “U” or a double triangle.

12. The seal of claim 8, wherein the seal has four, five or six layers.

13. The seal of claim 12 wherein the seal has five layers comprising: PE, PET, foil and PVdC or a combination thereof.

14. The seal of claim 13 wherein two of the five layers are comprised of PE and the other three layers are comprised of compounds selected from PET, foil and PVdC.

15. The seal of claim 14 wherein the seal has five layers comprising;
one of the layers comprised of PE is solid PE;
two of the deformation layers are PE or PET;
one of the deformation layers is foil; and
one of the deformation layers is f PVdC.

16. The seal of claim 15 wherein the seal has five layers, comprising;
the solid layer of PE is low density PE;
one of the deformation layers is PET;
one of the deformation layers includes medium density PE;
one of the deformation layers is foil; and
one of the deformation layers is PVdC.

17. The seal of claim 15 wherein the seal has five layers, comprising;
the solid layer of PE;
the other four layers are deformation layers are made of PE, PET, or foil; and
one of the deformation layers is PVdC;
wherein the deformation layer of PE is next to the solid layer of PE.

18. The seal of claim 12 wherein the seal is six layers, comprising layers made from compounds selected from PE, PET, foil, PVdC and polyolefin and combinations thereof.

19. The seal of claim 18, wherein the seal having six layers comprising;
two of the six layers made of PE, and four layers are made of materials selected from; PET, foil, PVdC and polyolefin;
wherein one of the PE layers is the solid layer.

20. The seal of claim 19, wherein the seal is six layers comprising;
two of the six layers made of PE, and the other four layers are deformation layers made of materials selected from PET, foil, PVdC and polyolefin;
wherein one of the PE layers is the solid layer; and
wherein the other PE layer is a deformation layer adjacent to the solid PE layer.

21. The seal of claim 1 wherein the facilitated rupturable seal is incorporated into a juice box and adapted for rupture with a straw.

22. The seal of claim 1 wherein the facilitated rupturable seal is incorporated into a pill dispensing card and adapted for rupture with hands or fingers to release the pill.

23. The seal of claim 1 wherein the facilitated rupturable seal is incorporated into a combination solid and liquid container and allows for rupture by pressing the pill through the seal into a liquid.

24. The seal of claim 1 having the deformation with an open-shaped pattern wherein the deformation layer has an uncut spot in a cut line forming a gap in the cut line.

25. A facilitated rupturable seal comprising a deformation layer and a layer free of deformation,
wherein the deformation layer is comprised of five of layers;
wherein the layer free of deformation is one layer;
wherein the deformation layer and the layer free of deformation are combined and fixed to each other,
wherein the combined deformation layer and layer free of deformation form a moisture and vapor resistant barrier;
wherein the deformation layer comprises:
five layers having a deformation;
wherein the deformation is in the shape of a pattern;
the deformation layers are stacked on top of one another,
wherein one deformation layer is medium density PE;
wherein the stacked layers are in the following order: second deformation layer, made of PVdC or PET; third deformation layer made of foil; fourth deformation layer made of polyolefin; fifth deformation layer made of PET;
wherein the layer free of deformation is low density PE with a thickness of about 0.05 mm; and
wherein the combined thickness of the deformation layers is about 0.25 to 0.30 mM.
